(19) United States
(12) Patent Application Publication
(10) Pub. No.: US 2016/0048009 A1
(43) Pub. Date: Feb. 18, 2016

(54) MICROSCOPE APPARATUS AND APPLICATIONS THEREOF

(71) Applicant: ENCELADUS IP LLC, Potomac, MD (US)

(72) Inventor: Ruhollah SHARIFI, Shahrestan-e Nazarabad (IR)

(21) Appl. No.: 14/459,092

(22) Filed: Aug. 13, 2014

(51) Int. Cl. G02B 21/00; G02B 21/06; G02B 21/36; G02B 7/02

(52) U.S. Cl. CPC G02B 21/00; G02B 7/02; G02B 21/06; G02B 21/36

(57) ABSTRACT

In an aspect, a microscope removably attachable to a portable electronic device includes a lens including an optical axis and configured to magnify at least a portion of an object. The microscope further includes a member configured to support the lens and removably attach to the portable electronic device. In another aspect, a microscope for viewing an object situated on a slide includes a lens including an optical axis and configured to magnify at least a portion of the object situated on the slide. The microscope further includes a member supporting the lens. In such aspect, the member includes a holder platform configured to position and hold the slide at a distance from the lens.

### BACKGROUND

Aspects of the present disclosure relate generally to a microscope apparatus, and more particularly to a portable microscope apparatus utilized for observation of various samples.

Conventionally, prior microscopes have included a magnifying device which is fixedly carried on a stand that supports a slide carrying or holding an objective to be observed. The stands are usually large and cumbersome and include a mechanism for moving the magnifying means with respect to the fixed object on the slide. Also, no means are provided for holding or retaining a movable object on the slide so that it may be observed during the examining procedure through the use of the magnifying means. Even though such prior devices are noted as being portable, such expression usually refers to merely disassembling the apparatus so that it may be conveniently placed into a box or other carrying means so that it may be transported from one place to another. Such apparatus is not portable in the sense that the unit may be used in a hand-held fashion and may be moved from place to place by the user during the examining procedure. This latter, true portability is useful in positioning the apparatus outdoors or anywhere in field work where there is apt to be no flat or stable support surface on which a conventional microscope can be conveniently supported.

As such, improvements are needed to provide a compact and lightweight microscope, which can be used in a variety of settings, including in the field, without the necessity for a working surface or support for the microscope, and which is of simple construction and operation and which provides flexibility of use allowing it to be used to observe a variety of objects which can be mounted in a variety of ways for observation.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with an aspect, a microscope removably attachable to a portable electronic device includes a lens including an optical axis and configured to magnify at least a portion of an object. The microscope further includes a member configured to support the lens and removably attach to the portable electronic device.

In another aspect, a microscope for viewing an object situated on a slide includes a lens including an optical axis and configured to magnify at least a portion of the object situated on the slide. The microscope further includes a member supporting the lens. In such aspect, the member includes a holder platform configured to position and hold the slide at a distance from the lens.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

In order to facilitate a fuller understanding of the present disclosure, reference is now made to the accompanying drawings, in which like elements are referenced with like numerals. These drawings should not be construed as limiting the present disclosure, but are intended to be illustrative only.

FIG. 1A is a schematic diagram illustrating an example microscope in accordance with an aspect of the present disclosure.

FIG. 1B is schematic diagram illustrating a profile view of the example microscope in accordance with an aspect of the present disclosure.

FIG. 2A is a schematic diagram illustrating an aspect of a microscope removably attached to a mobile device and in accordance with an aspect of the present disclosure.

FIG. 2B is a schematic diagram illustrating another aspect of the microscope removably attached to the mobile device and in accordance with an aspect of the present disclosure.

FIG. 3A is a conceptual diagram illustrating an example optical system in accordance with an aspect of the present disclosure.

FIG. 3B is a conceptual optical diagram illustrating a further example of a lens system in accordance with an aspect of the present disclosure.

FIG. 4 is a conceptual diagram illustrating the operation of a microscope system 400 with a microscope slide.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts. In an aspect, the term “component” as used herein may be one of the parts that make up a system, may be hardware or software, and may be divided into other components.

Various aspects of a microscope apparatus may be illustrated by describing components that are coupled, attached, and/or joined together. As used herein, the terms “coupled”, “attached”, and/or “joined” are interchangeably used to indicate either a direct connection between two components or, where appropriate, an indirect connection to one another through intervening or intermediate components. In contrast, when a component is referred to as being “directly coupled”, “directly attached”, and/or “directly joined” to another component there are no intervening elements shown in said examples.

Relative terms such as “front” or “back” and “lower” or “bottom” and “upper” or “top” may be used herein to describe one element's relationship to another element illustrated in the drawings. It will be understood that relative terms are intended to encompass different orientations of a microscope apparatus in addition to the orientation depicted in the drawings. By way of example, if aspects of a fluid irrigation pump system shown in the drawings are turned over, elements described as being on the “bottom” side of the other element would then be oriented on the “top” side of the other elements as shown in the relevant drawing. The term “bottom” can therefore encompass both an orientation of “bottom” and “top” depending on the particular orientation of the drawing.

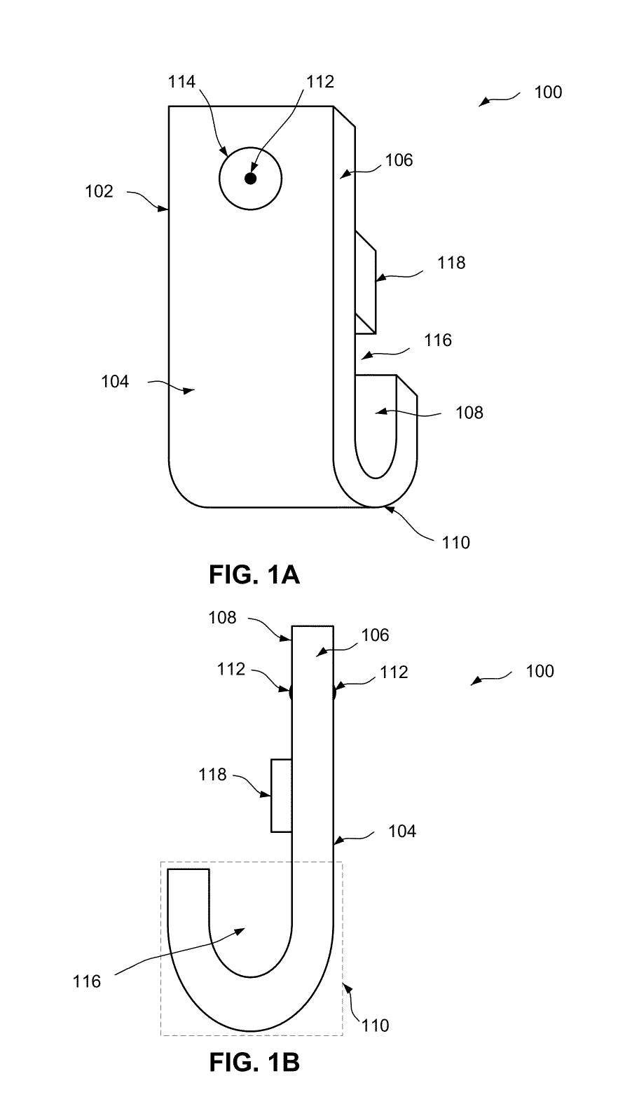

Referring to FIG. 1A, in an aspect, an example microscope 100 may include a body 102, comprising a front 104, sides 106, and back 108. In one aspect, the microscope 100 may be form a shape similar to the letter “J”, wherein the body 102 is flat and having holder 110 in the shape of a hook or “U”, or any other shape towards the bottom, as shown in FIG. 1A. Microscope 100 may include a lens 112 having an optical axis and configured to magnify at least a portion of an object situated on a slide or in front of the lens 112. In addition, the microscope 100 may include a member supporting the lens 112. In some aspects, the member may include a holder platform 118 configured to position and hold a slide at a distance from the lens. Furthermore, the lens 112 may be situated or arranged within a lens region 114. The lens region 114 may be circular and/or cylindrical in shape and may extend from the front 104 of the body 102 of microscope 100 to the back 108. In some instances, the lens region 114 may encompass the lens 112. Additionally, lens 112 may be a single lens. In some aspects, the holder 110 may alternatively be referred to as a member.

For example, the lens region 114 may house the lens 112, so that the front 104 and back 108 of the body 102 of the microscope 100 do not extend over the lens 112. In a preferred aspect, the front 104 and back 108 of the body 102 of the microscope 100 extend up to the lens region 114. The lens region 114 may be a cylindrical shell, in that the lens region 114 is a solid contained between two cylinders having the same center and axis (concentric cylinders), and wherein the area within the smaller cylinder is empty. As such, the lens 112 may be situated within the area within the smaller cylinder that is empty. As a result, the objects may be viewed through the lens 112 without any obstructions from the body 102 and/or the lens region 114.

Further, in an aspect, the lens 112 may be a convex lens, and in particular, a biconvex and/or plano-convex. For example, if the lens 112 is configured as a convex lens, then a collimated beam of light passing through the lens 112 will be converged (or focused) to a spot behind the lens 112. It should be understand, that the sport of convergence is located at an adjust position from the front 104 of the body 102 of the microscope 100. Moreover, the collimated beam of light, or any source of light, may travel in a direction from the back 108 of the microscope 100, through the lens 112, to the front 104. In this example, the lens 112 is called a positive or converging lens.

Additionally, in an aspect, the microscope 100 may have a total length of less than 70 millimeters (mm), a width of less than 15 mm, and a depth of less than 2 mm, preferably 1 mm in thickness. For example, side 106 may be 1 mm in length. The lens region 114 may have a diameter up to the width of the microscope 100 (e.g., 15 mm). The lens 112 may be configured with optical power between a range of 100 to 1250 dioptre. As such, the lens 112 may be configured with magnification ranging from 25 to 312.5 times corresponding to the optical power the lens 112 is configured with. Dioptre may be a unit of measurement of an optical power or refractive power of a lens, and may be equal to a reciprocal of a focal length (e.g., in metres) of the lens.

Additionally, the focal point of lens 112 may comprise a focal length ranging from 0.0008 to 0.01 meters. A focal point may be a point at which rays and/or waves meet after reflection or refraction, or the point from which diverging rays and/or waves appear to proceed. In other words, the focal point may be a point on an axis of a lens to which parallel rays of light converge or from which they appear to diverge after refraction or reflection. In some instances, the focal length of focal point may correspond to the optical power of the lens 112 and to the object distance. The object distance may correspond to the distance between the object and the center point of lens 112. The focal point of the lens 112 may be adjusted based on one or more factors such as one or more of the diameter of the lens 112 which may range from 0.1 to 0.5 millimeters, the optical power of the lens, and object distance. In a specific aspect, the lens 112 may be configured with a radius of 0.2 millimeters. As such, the curvature may be 385 dioptre and positive in value. Furthermore, the microscope 100 may be less than or equal to 3 grams in weight total.

In a further aspect, the holder 110 may be configured to hold objects of interest in slot region 116 of the lens 112. For example, a microscope slide with dimensions of approximately 75 mm in length and 26 mm in width and 1 mm in thickness may be secured in place by the holder 110. However, all types of microscope slides are compatible with the holder 110 of microscope 100. In certain instances, the object and/or specimen to be examined is lined up with the lens 112 so that it may be viewed at a microscopic level. The microscope slide may be held in place between the holder 110 and holder platform 118 located at the back 108 of microscope 100. The size of the holder platform 118 may be configured based on the desired specifications of the lens 112. For instance, the size of the holder platform 118 may correspond to the desired object distance, optical power of lens 112, and focal length.

The holder platform 118 may include or correspond to a protrusion on an interior of the member (e.g., holder 110) and opposite a viewing side of the member (e.g., holder 110). Further, the member (e.g., holder 110) may include an angled, curved, hinged, or shaped portion configured to support a slide at the viewing position. In such aspect, the slide may be positioned substantially parallel to the lens 112. Additionally, the slide may be inserted into an interior formed by the angled portion of the member (e.g., holder 110) and in contact with the holder platform 118. As such, the holder platform 118 may position the object for viewing substantially perpendicular to the optical axis of the lens 112. An optical axis may be a line passing through a center of curvature of a lens or spherical mirror and parallel to an axis of symmetry. Accordingly, holder platform 118 may position the slide at a distance where a magnified image formed is at an optimum or most focus. In such aspect, the position may be based on an optical power and/or a focal length of the lens 112. The holder platform 118 may alternatively be referred to as a holding mechanism for holding or supporting the slide.

In an instance, the holder 110 may be bendable in order for microscope slides of a plurality of shapes and thickness to be able to be secured in place and viewed by microscope 100. This arrangement allows several slide-mounted objects and/or specimens to be quickly inserted and removed from the microscope 100, labeled, transported, and stored in appropriate slide cases or folders. In other aspects, the holder 110 may be of any shape and material capable of holding a microscope slide in place for viewing through the lens 112. As such, the holder 110 may be configured in a shape different from the one depicted in FIG. 1A. For example, the holder 110 may be a clamp or a fastener configured to secure and/or mount a microscope slide on to the slot region 116 of microscope 100 for viewing.

In other aspects, the microscope 100 may operate or function without the use of an attached light source. In such aspect, microscope 100 may use natural or ambient light to view the object. Additionally, in an aspect, an object may be magnified by microscope 100 with only a natural light source. As such, a condenser (e.g., a lens that serves to concentrate light from the light source that is in turn focused through the object and magnified by an objective lens) may not be used with microscope 100.

Moreover, a light source may be used to illuminate an object and detached from the microscope 100 and/or microscope slide. That is, the light source may be configured to attach to the microscope 100. Further, microscope 100 may be configured to include light source as part of the apparatus. In this instance, microscope 100 may include a power source, such as batteries, in order to power the light source when examining a specimen located of microscope slide. For instance, the light source may be one or more of a natural light, ambient light, light emitting diode (LED), fluorescent light, incandescent light, and any other number of light sources.

Referring to FIG. 1B, in another aspect, a side view of microscope 100 of FIG. 1B is shown. Again, microscope 100 may include a body 102 comprising a front 104, side 106, and back 108. Lens 112 may extend from the front 104 of microscope 100 to the back 108. Even though the lens 112 is depicted as protruding out of both the front 104 and back 108 of microscope 100, lens 112 may be configured to be less than the size of the side 106 of microscope 100. In some instances, microscope 100 may be configured to include a holder 110, as depicted by the region of microscope 100 encompassed by the boxed dotted lines.

The holder 110 may be of any shape and material capable of holding a microscope slide in place for viewing through the lens 112. As such, the holder 110 may be configured in a shape different from the one depicted in FIG. 1A. For example, the holder 110 may be a clamp or a fastener configured to secure and/or mount a microscope slide on to the slot region 116 of microscope 100 for viewing. The slot region 116 may also be of any shape and size capable of holding an object and/or specimen meant for viewing through lens 112 in place. In a non-limiting aspect, the slot region 116 may comprise a region configured to secure a microscope slide with dimensions of approximately 75 mm in length and 26 mm in width and 1 mm in thickness.

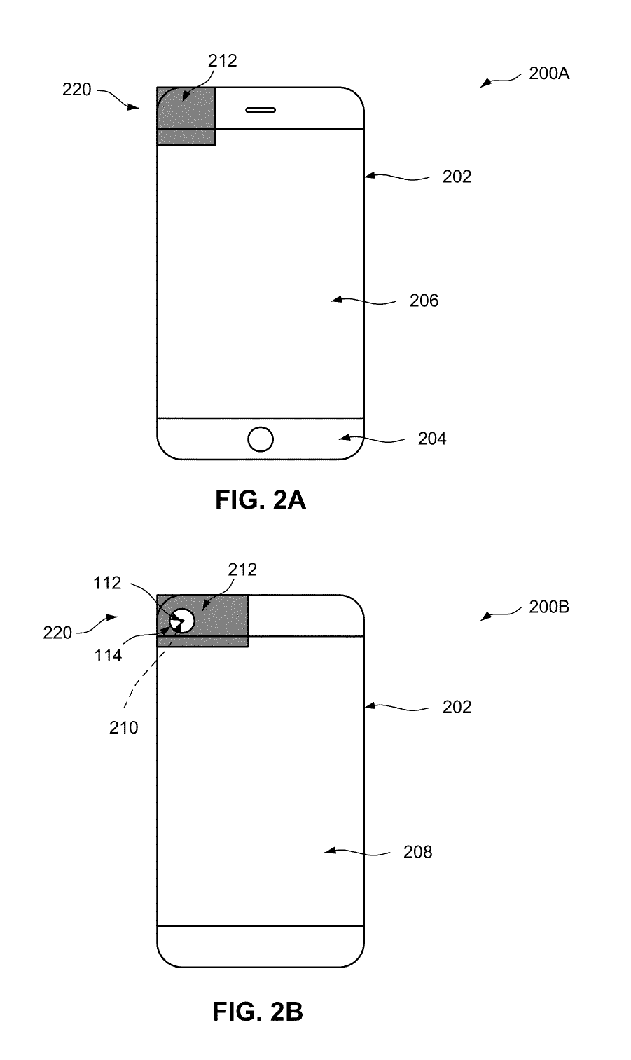

Referring to FIGS. 2A and 2B, in an aspect, the microscope, such as microscope 220 of FIGS. 1A and 1B, may be attachable to a mobile device, such as mobile device 202. FIG. 2A depicts a front view 200A of the mobile device 202 with the microscope 100 removably attached. FIG. 2B depicts a back view 200B of the mobile device 202 with the microscope 220 removably attached. In such aspects, a removably attachable microscope 220 may be conveniently attached and detached freely and/or without significant effort by a user to/from the mobile device 202.

In an aspect, microscope 220 may be partially mounted or attached to the front 204 of mobile device 202 in order to secure the microscope 220 in place over the an imaging device 210 of mobile device 202. In some instances, the imaging device 210 may be configured in the top left corner of the back 208 of mobile device 202. Imaging device 210 may be configured to take photos and/or video recordings. Furthermore, mobile device 202 may include screen 206 which may be configured to provide a visual representation of objects being viewed through imaging device 210. In some aspects, the imaging device 210 may include an image capture device such as a camera.

As such, microscope 220 may be mounted on to mobile device 202 in such a manner such that lens 112 and lens region 114 are situated over imaging device 210. For example, microscope 220 may include a member 212 configured to support the lens 112 including an optical axis and configured to magnify at least a portion of an object. In other words, microscope 100 may include or otherwise be formed of a member 212 and the lens 112. Specifically, the member 212 may be configured to removably attach to an exterior of the mobile device 202 such that the lens 112 is aligned to a window covering an aperture above the imaging device 210. In addition, the member 212 may include an angled, curved, hinged, and/or a shaped portion adapted or configured to wrap around a portion of the mobile device 202 and over the imaging device 210. In some aspects, the position of the lens 112 may be adjustable relative to a previous position of the lens 112 on the member 212.

Additionally, an object, such as a microscope slide, may be secured on to microscope 220, while microscope 220 is mounted on mobile device 202. As a result, when a light source is applied from behind the object, such as microscope slide, the light from the light source may travel through the lens 112 of microscope 220 and become magnified. The magnified light is then captured by the imaging device 210 (e.g., camera) of mobile device 202, so that a real time visual of the object being magnified by microscope 100 is shown on screen 206. In other aspects, the mobile device 202, which may be hand-held, may be brought in close proximity to an object to be viewed, such that a magnified image of the object is displayed on the display of the mobile device 202. In any aspect, a light source separate from the microscope 220 may illuminate the object. In other aspect, a light source of the mobile device 202 may illuminate the object.

Although shown in certain configuration, it should be understood that the microscope 100 may be attached to mobile device 202 in any number of manners. Further, for example, the microscope 100 may be integral or otherwise integrated within the mobile device 202. In such integrated aspects, the lens may be adjustable within the mobile device 202. Further, in some aspects, mobile device 202 may alternatively be referred to as a portable and/or hand-held electronic device including an imaging device (e.g., imaging device 210).

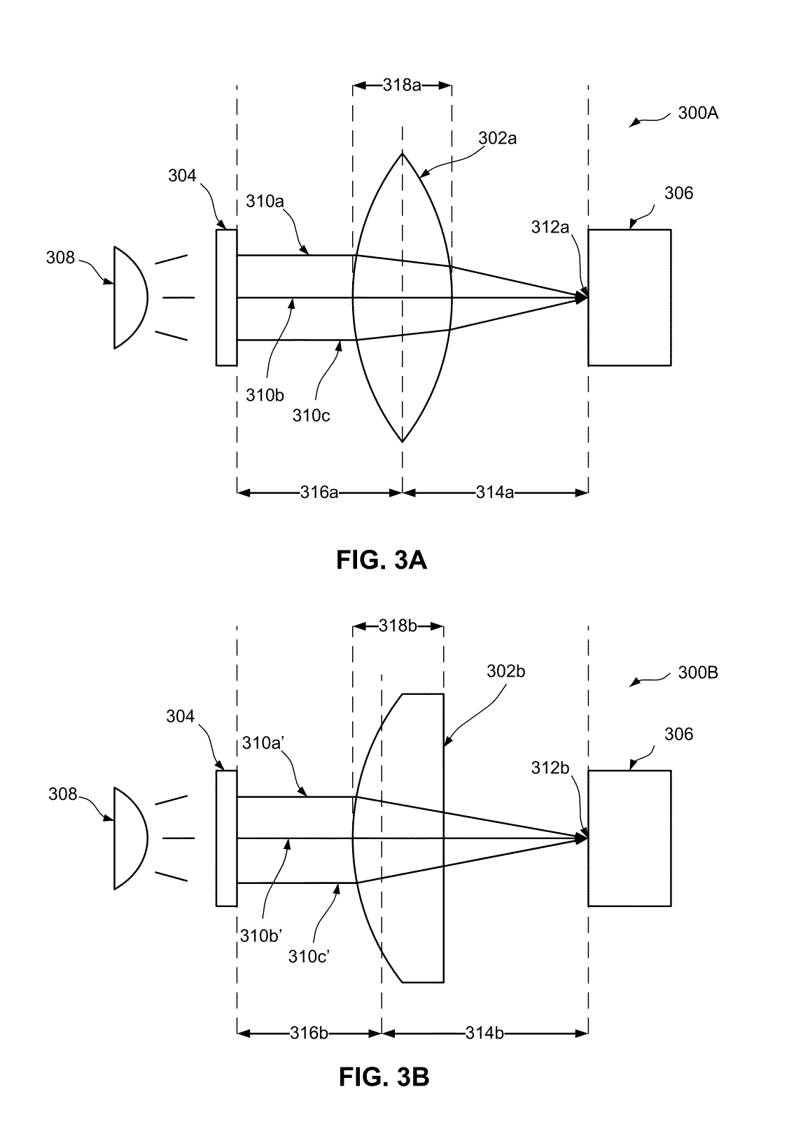

Referring to FIGS. 3A and 3B, a conceptual diagram illustrating the operation of a lens, such as lens 112 of FIGS. 1A and 1B. In FIG. 3A, lens system 300A illustrates the operation of a biconvex lens 302a of a lens, such as lens 112 of microscope 100 (FIGS. 1A and 1B). In FIG. 3B, lens system 300B alternatively illustrates the operation of a plano-convex lens 302b of a lens, such as lens 112 of microscope 100 (FIGS. 1A and 1B).

In an aspect, in FIG. 3A, a biconvex lens 302a may be configured between a viewer 306 and an object 304, such as a microscope slide, wherein the biconvex lens 302a may be configured to magnify the object 304 for the viewer 306. For example, a light source 308 may provide light to lens system 300A, and in particular, to object 304 located at an object distance 316a from biconvex lens 302a. As a result, the rays of light, 310a, 310b, and 310c are emitted from object 304 and travel into biconvex lens 302a. Biconvex lens 302a refracts the rays of light 310a, 310b, and 310c as they pass through biconvex lens 302a and converge at focal point 312a. In some instances, viewer 306 may be located at focal point 312a. Additionally, viewer 306 may be an eye of a user or an image capturing device (e.g., charge coupled device (CCD) and/or camera).

Further, in an aspect, biconvex lens 302a may be an equiconvex lens, wherein the surfaces have the same radius of curvature. In other instances, the surfaces may have different radius of curvature. Moreover, the biconvex lens 302a may be configured with optical power between a range of 100 to 1250 dioptre. As such, the biconvex lens 302a may be configured with magnification ranging from 25 to 313 times corresponding to the optical power the biconvex lens 302a is configured with.

Additionally, the focal point 312a of biconvex lens 302a may comprise a focal length 314a ranging from 0.0008 to 0.01 meters. In some instances, the focal length 314a of focal point 312a may correspond to the optical power of the biconvex lens 302a and to the object distance 316a. The object distance 316a may correspond to the distance between the object 304 and the center point of biconvex lens 302a. The focal point 312a of the biconvex lens 302a may be adjusted based on one or more factors such as one or more of the diameter of the biconvex lens 302a which may range from 0.1 to 0.5 millimeters, the optical power of the lens, the lens thickness 318a, and object distance 316a. In a specific aspect, the biconvex lens 302a may be configured with a radius of 0.2 millimeters. As such, in some non-limiting aspects, the curvature may be 385 dioptre and positive in value.

In another aspect, in FIG. 3B, a plano-convex lens 302b may be configured between a viewer 306 and an object 304, such as a microscope slide, wherein the plano-convex lens 302b may be configured to magnify the object 304 for the viewer 306. For example, a light source 308 may provide light to lens system 300B, and in particular, to object 304 located at an object distance 316b from plano-convex lens 302b. As a result, the rays of light, 310a′, 310b′, and 310c′ are emitted from object 304 and travel into plano-convex lens 302b. Plano-convex lens 302b refracts the rays of light 310a′, 310b′, and 310c′ as they pass through plano-convex lens 302b and converge at focal point 312b. In some instances, viewer 306 may be located at focal point 312b.

In a specific aspect, plano-convex lens 302b may be configured with a focal point 312b corresponding with a focal length 314b and a center thickness 318b. Similarly, plano-convex lens 302b may be configured with optical power between a range of 100 to 1250 dioptre and a magnification ranging from 25 to 312.5 times. Additionally, the focal point 312b of plano-convex lens 302b may comprise a focal length 314a ranging from 0.0008 to 0.01 meters. The focal point 312a of the biconvex lens 302a may be adjusted based on one or more factors such as one or more of the diameter of the plano-convex lens 302b which may range from 0.1 to 0.5 millimeters, the optical power of the lens, the lens thickness 318b, and object distance 316b. In a specific aspect, the plano-convex lens 302b may be configured with a radius of 0.2 millimeters. As such, the curvature may be 385 dioptre and positive in value.

The application of the lens according to the present aspects, such as those shown in or similar to FIGS. 3A and 3B, for example, is not limited to a single lens microscope. The same or a similar lens design may be used to the advantage of other applications, including fiber optic coupling and/or imaging, medical endoscopes, optoelectronic component coupling and/or imaging, laser beam shaping, focusing and/or imaging, optical disc readers/writers, and other applications, without limitation.

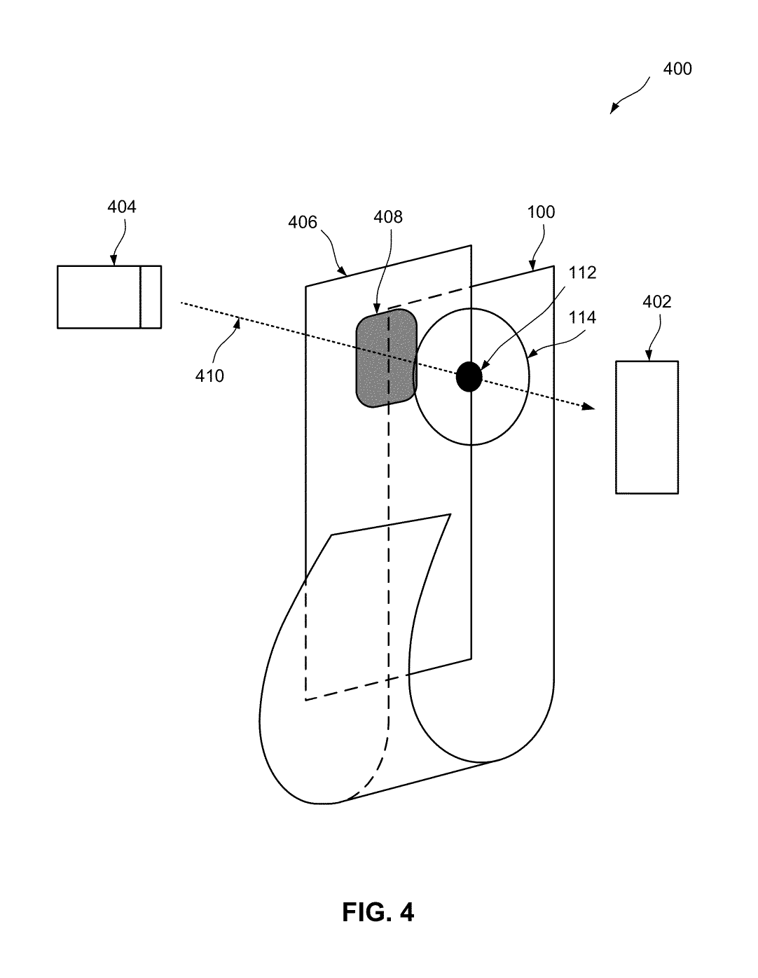

Referring to FIG. 4, a conceptual diagram illustrating the operation of a microscope system 400 with a microscope slide, such as microscope slide 406, mounted on to a microscope, such as microscope 100 (FIG. 1). For example, microscope slide 406 may include a specimen 408 to be viewed through the lens 112 of microscope 100. In some instances, microscope slide 406 may be secured to microscope 100 via holder 110 (FIG. 1) so that specimen 408 is aligned with lens 112 and lens region 114. Once aligned, a light source 404 may be configured to provide light 410 from behind the microscope slide 406. As a result, the beam of light 410 may travel through specimen 408 and into lens 112 of the microscope 100 where the visual representation of specimen 408 is magnified. The resulting magnified visual representation of specimen 408 may be available for viewing by a viewer 402. In certain instances, viewer 402 may be one or more of an eye, a camera, such as a camera mounted on a mobile device (e.g., mobile device 202 of FIG. 2), video recorder, and any other device capable of capturing light.

In certain aspects, the light source 404 may be detached from the microscope 100 and microscope slide 406. For example, the light source 404 may be one or more of a natural light, light emitting diode (LED), fluorescent light, incandescent light, and any other number of light sources. In an optional aspect, the light source 404 may be configured to attach to the microscope 100. For example, microscope 100 may be configured to include light source 404 as part of the apparatus. In this instance, microscope 100 may include a power source, such as batteries, in order to power the light source 404 when examining a specimen 408 located of microscope slide 406. Microscope 100 may be configured to include a holder region (e.g., slot region 116) between the lens 112 and the light source 404 in order for a microscope slide 406 to be secured within the holder region. Once secured, the light source 404 may be turned on (e.g., via a switch and/or button) and light 410 may be provided on to the specimen 408 and microscope slide 406. The light 410 may then travel through lens 112 of microscope 100 where the light 410 is then magnified and captured by viewer 402.

It should be understood that the lens described herein with respect to FIGS. 1-4 may be a lens having the same or similar optical characteristics with respect to each application. Further, the lens disclosed herein with respect to FIGS. 1-4 may be at least any one of a ball lens, a glass ball lens, a double convex lens, a meniscus lens, an aspheric lens, a kino-form-corrected aspheric double convex lens, a kino-form-corrected aspheric meniscus, a flat-field apochromatic single-element simple microscope lens, a plano/spheric convex lens, a plano/aspheric convex lens, a plano/diffractive lens, a plano/diffractive-spheric convex lens, a plano/diffractive-aspheric convex lens, a diffractive plano/spheric convex lens, a diffractive plano/aspheric convex lens, a double convex spheric/spheric lens, a double convex spheric/aspheric lens, a double convex aspheric/aspheric lens, a double convex diffractive-spheric/aspheric lens, a double convex spheric/diffractive-aspheric lens, a double convex aspheric/diffractive-aspheric lens, a double convex diffractive-aspheric/diffractive-aspheric lens, a spheric/spheric meniscus lens, a spheric/aspheric meniscus lens, an aspheric/aspheric meniscus lens, a diffractive/diffractive meniscus lens, a diffractive-spheric/spheric meniscus lens, a diffractive-spheric/diffractive-spheric meniscus lens, a diffractive-spheric/aspheric meniscus lens, a spheric/diffractive-aspheric meniscus lens, an aspheric/diffractive-aspheric meniscus lens, and a diffractive-aspheric/diffractive-aspheric meniscus lens.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, or 35 U.S.C. §112(f), unless the element is expressly recited using the phrase “means for” or, in the case of a method claim, the element is recited using the phrase “step for.”

What is claimed is:

1. A microscope removably attachable to a portable electronic device, comprising:
a lens including an optical axis and configured to magnify at least a portion of an object; and
a member configured to support the lens and removably attach to the portable electronic device.

2. The microscope of claim 1, wherein the member is further configured to removably attach to an exterior of the portable electronic device such that the lens is aligned to a window covering an aperture above an imaging device.

3. The microscope of claim 1, wherein the member includes an angled portion adapted to wrap around a portion of the portable electronic device and over a portion of an imaging device.

4. The microscope of claim 1, wherein a position of the lens is adjustable relative a previous position of the lens on the member.

5. The microscope of claim 1, wherein the lens is a single lens having an optical axis.

6. The microscope of claim 5, wherein the single lens corresponds to one of a convex lens, a plano-convex lens, or a biconvex lens.

7. The microscope of claim 5, wherein the single lens includes an optical power value between 100 and 1250 dioptre.

8. The microscope of claim 5, wherein a diameter of the single lens falls within a range of 0.1 millimeters to 0.5 millimeters.

9. The microscope of claim 1, wherein a light source separate from the microscope illuminates the object.

10. The microscope of claim 1, wherein the portable electronic device includes a mobile device.

11. A microscope for viewing an object situated on a slide, comprising:
a lens including an optical axis and configured to magnify at least a portion of the object situated on the slide; and
a member supporting the lens, wherein the member includes a holder platform configured to position and hold the slide at a distance from the lens.

12. The microscope of claim 11, wherein the holder platform includes a protrusion on an interior of the member and opposite a viewing side of the member.

13. The microscope of claim 11, wherein the member includes an angled portion configured to support the slide at the viewing position, and wherein the slide is positioned substantially parallel to the lens.

14. The microscope of claim 11, wherein the slide is inserted into an interior formed by the angled portion of the member and in contact with the holder platform.

15. The microscope of claim 11, wherein the holder platform positions the object for viewing substantially perpendicular to the optical axis of the lens.

16. The microscope of claim 11, wherein the lens is a single lens having an optical axis.

17. The microscope of claim 16, wherein the single lens corresponds to a convex lens or a biconvex lens.

18. The microscope of claim 16, wherein the single lens includes an optical power value between 100 and 1250 dioptre.

19. The microscope of claim 16, wherein a diameter of the single lens falls within a range of 0.1 millimeters to 0.5 millimeters.

20. The microscope of claim 11, wherein a light source separate from the microscope illuminates the object.
